(19) United States
(12) Patent Application Publication
(10) Pub. No.: US 2005/0237420 A1
(43) Pub. Date: Oct. 27, 2005

(54) Camera system and camera main unit

(75) Inventor: Kouzou Kokubun, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/109,729

(22) Filed: Apr. 20, 2005

(30) Foreign Application Priority Data
Apr. 22, 2004 (JP) 2004-126996

(51) Int. Cl. H04N 5/225

(52) U.S. Cl. 348/340

(57) ABSTRACT

The present invention provides a camera system having a camera head and a camera main unit, and provides the camera main unit thereof, which are easy to use. Upon attachment of the camera head to the camera main unit, the camera head sends head information about the camera head to the camera main unit. Upon receipt of the head information, the camera main unit rewrites information such as processing variables of the camera main unit. For example, when a camera head incorporating a single focus lens is attached to the camera head, electronic zooming is performed instead of optical zooming in response to a zooming operation performed through a cross key.

### BACKGROUND OF THE INVENTION

1. Field of the Invention

The present invention relates to a camera system including: plural types of camera heads, each of which has an image taking optical system and an image pickup device; and a camera main unit to which any of the plural types of camera heads is interchangeably attached and which receives an image signal from the attached camera head and performs signal processing.

2. Description of the Related Art

There has been proposed a camera system including a camera main unit and a plug-in unit incorporating an image pickup device and an image taking optical system integrally, in which, once the plug-in unit is attached to the camera main unit, information retained in the plug-in unit is transmitted to the camera main unit to enable image taking using the image taking optical system of the plug-in unit (see Japanese Patent Application No. 8-172561). Such a camera system, whose image taking optical system, that is, the image taking lens, can be changed simply by attaching the plug-in unit to the camera main unit, is quite easy to handle and permits a person who has no expertise in camera system to easily change the image taking lens. There has been proposed a similar camera system that includes an interchangeable lens unit having a finder optical system (see Japanese Patent Application No. 2000-187268 for example).

However, either of the above references merely shows a camera system including plural types of camera heads or plural types of plug-in units that can be attached to a common camera main unit by way of example. None of these references discusses an example including plural types of camera main units.

If plural types of camera heads and plural types of camera main units are used in a camera system, the camera system may not be able to perform image taking depending on the combination of a camera head and a camera main unit. Even if the image taking can be performed, part of the functions of the camera main body may not be available, which cannot be expected by a user. Such situations impair usability of the camera system, even though the plural types of camera heads and plural types of camera main units are prepared.

In addition, many of recent digital cameras have not only the function of taking an image with an interchangeable lens, but also the function of reproducing a taken image at a camera main unit. These functions are independent of the interchangeable lens and incorporated in the camera main unit. If the lens needs to be attached to the camera main unit when a user uses these functions, the user has to attach the lens to the camera main unit every time when he/she uses these functions even when the lens is not used, which also sacrifices usability of the camera system.

### SUMMARY OF THE INVENTION

The present invention has been made in view of the above circumstances, and provides a camera system having a camera head and a camera main unit, which are easy to use.

A first camera system according to the present invention includes: a plurality of types of camera heads each having an image taking optical system and an image pickup device; and a camera main unit to which any of the plurality of types of camera heads is interchangeably attached and which receives an image signal from the attached camera head and performs signal processing,
wherein the camera main unit includes:
operation means for providing an instruction to the camera main unit and to the camera head attached to the camera main unit in response to an operation; and
control means for controlling, upon receipt of an instruction from the operation means, the operation of the camera main unit and the camera head attached to the camera main unit in accordance with a control description obtained from association information in which instructions from the operation means are associated with control descriptions, the association information being retained in the control means,
wherein in response to attachment of the camera head to the camera main unit, the control means rewrites the association information according to the camera head attached to the camera main unit.

According to the first camera system, even if any type of camera head is attached to any type of camera main unit, the control means of the camera main unit appropriately controls the camera system in accordance with the control description obtained from the association information.

For example, when a single focus lens is attached to the camera main unit, the control means can rewrite the association information so that electronic zooming can be performed instead of optical zooming.

With this arrangement, there can be realized a camera system that appropriately operates according to a combination of a camera head and a camera main unit when the camera head is attached to the camera main unit, which is user-friendly.

A second camera system according to the present invention includes: a plurality of types of camera heads each having an image taking optical system and an image pickup device; and a plurality of types of camera main units, to each of which any of the plurality of types of camera heads is interchangeably attached and each of which receives an image signal from the attached camera head and performs signal processing,
wherein, of the plurality of types of camera main units, at least one type of camera main unit includes:
determination means for determining whether an unsupportable function is included in the functions of the camera head attached to the one type of camera main unit; and
warning means for warning when the unsupportable function is included.

According to the second camera system, when the camera head is attached to the camera main unit, the determination means of the camera main unit determines whether an unsupportable function is included in the functions of the camera head attached to the one type of camera main unit. If it is determined that the camera head includes an unsupportable function, the warning means performs warning.

When a user operates the camera main unit to take an image using this camera system but a function required by the user's operation cannot be implemented by the camera head attached to the camera main unit, it is possible to notify the user that the user's operation is invalid by way of warning as described above.

A third camera system according to the present invention includes: a camera head having an image taking optical system and an image pickup device; and a camera main unit, to which the camera head is removably attached and which receives an image signal from the attached camera head and performs signal processing,
wherein the camera system includes a first mode for operation performed in cooperation with the attached camera head and a second mode for operation performed independently of the camera head, and
wherein the camera main unit performs the operation in the second mode when the camera head is not attached to the camera main unit.

According to the third camera system, even when the camera head is not attached to the camera head, the operation in the second mode can be performed. For example, if the second mode is a reproduction mode and the camera main unit has a display device, a user can enjoy watching reproduced images displayed on the display screen of the display device without using the camera head.

With this arrangement, there can be realized a camera system that operates only with the camera main unit even when the camera head is not attached to the camera main unit, which is easy to use.

To provide such a camera system that is easy to use, the second camera system includes a first camera main unit to which any of a plurality of types of camera heads each having an image taking optical system and an image pickup device is interchangeably attached, and which receives an image signal from the attached camera head and performs signal processing,
wherein the camera main unit includes:
operation means for providing an instruction to the camera main unit and to the camera head attached to the camera main unit in response to an operation; and
control means for controlling, upon receipt of an instruction from the operation means, the operation of the camera main unit and the camera head attached to the camera main unit in accordance with a control description obtained from association information in which instructions from the operation means are associated with control descriptions, the association information being retained in the control means,
wherein in response to attachment of the camera head to the camera main unit, the control means rewrites the association information according to the camera head attached to the camera main unit.

Further, to provide such a camera system that is easy to use, the second camera system includes a second camera main unit, which is one type of camera main unit of a plurality of types of camera main units, to which any of a plurality of types of camera heads each having an image taking optical system and an image pickup device is interchangeably attached, and which receives an image signal from the attached camera head and performs signal processing,
wherein the camera main unit includes:
determination means for determining whether an unsupportable function is included in the functions of the camera head attached to the one type of camera main unit; and
warning means for warning when the unsupportable function is included.

As described above, there are provided a camera system having a camera head and a camera main unit and the camera main unit thereof, which are easy to use.

### BRIEF DESCRIPTION OF THE DRAWINGS

FIG. 1 shows a camera system according to an embodiment of the present invention;

FIG. 2 is a block diagram showing an electric system of a camera main unit 1b and a camera head 1a attached to the camera main unit 1b;

FIG. 3 is a flowchart showing an initialization processing procedure that is performed by a CPU of a camera main unit and a CPU of a camera head in cooperation with each other;

FIG. 4 is a diagram showing possible combinations of image taking lens and image pickup device of various types, which can be incorporated in a camera head;

FIG. 5 is a diagram showing SDRAM capacities used in the processing performed in step S307 of the flowchart shown in FIG. 3;

FIG. 6 is a diagram showing warning messages displayed on an LCD display panel when the processing in step S304 or step S308 shown in FIG. 3 is performed;

FIG. 7 is a diagram showing processing for rewriting the contents of association information, which is performed by the CPU;

FIG. 8 is a diagram showing the same arrangement as that of the camera main unit shown in FIG. 2 except that a sound decoder called MP3 decoder is incorporated therein; and

FIG. 9 is a diagram showing an example of the processing in step S302 shown in FIG. 3.

### DETAILED DESCRIPTION OF THE INVENTION

In the following, embodiments of the present invention will be described.

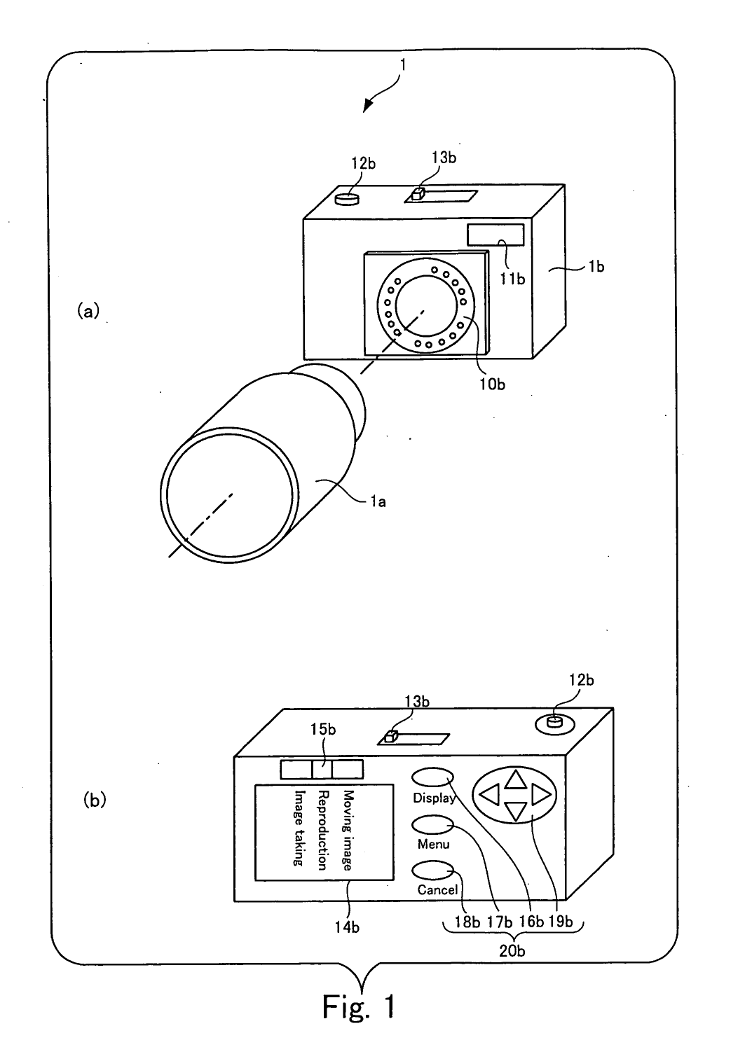

FIG. 1 shows a camera system according to an embodiment of the present invention.

Part (a) of FIG. 1 shows a camera system 1 that includes a camera head 1a and a camera main unit 1b, which are obliquely viewed from above. Part (b) of FIG. 1 shows the back face of the camera main unit 1b that is obliquely viewed from above. Parts (a) and (b) of FIG. 1 show the camera head 1a as one of plural types of camera heads and the camera main unit 1b as one of plural types of camera main units as examples.

Part (a) of FIG. 1 show the camera head 1a that has an image taking optical system and an image pickup device and the camera main unit 1b that receives an image signal from the camera head la and performs signal processing, which are separately illustrated.

Once a head mount of the camera head 1a is attached to a head mount 10b of the camera main unit 1b along the chain line, each of the mount contacts of one mount is connected to a corresponding one of the other mount, and thus, the camera head 1a and the camera main unit 1b are electrically connected to each other.

Each of the multiple mount contacts serves for communication or power supply and allows communication from the camera main unit 1b to the camera head 1a, communication from the camera head 1a to the camera main unit 1b, or power supply from the camera main unit 1b to the camera head 1a.

Above the head mount 10b, a flash emitting window 11b is disposed, and a flash emitting device for emitting a flash through the flash emitting window 11b is incorporated in the camera main unit 1b. On the top surface of the camera main unit 1b, there is disposed a power switch 13b, and the camera main unit 1b is activated by pressing the power switch 13b. When the camera head 1a is not attached to the camera main unit 1b, image and sound reproduction can be performed only by the camera main unit 1b. When the camera head 1a is attached to the camera main unit 1b, the power is also supplied to the camera head 1a. Thus, at the push of a release button 12b, the image taking lens captures subject light and an image of the subject is taken.

As shown in part (b) of FIG. 1, disposed on the back face of the camera main unit 1b are a switch group 20b for providing operational instructions to the camera head 1a and a display device for displaying images. The display device is a LCD panel 14b of a LCD in this case. In response to an operation made through the switch group 20b, the camera main unit 1b provides an instruction to the camera main unit 1b and to the camera head 1a attached to the camera main unit 1b. The switch group 20b is the operation means according to the present invention.

The switch group 20b includes: a mode selecting switch 15b for selecting one of an image taking mode, a reproduction mode, and a moving image mode; a display switch 16b for displaying an image on the LCD panel 14b; a menu switch 17b for displaying a menu on the LCD panel 14b; a cross key 19b for selecting one of the items in the menu displayed on the LCD panel 14b; a cancel switch 18b for canceling the item selected by the cross key 19b; and the like. For example, when the image taking mode is selected by the mode selecting switch 15b, the upper and lower key of the cross key 19b becomes a zoom switch, or when the reproduction mode is selected by the mode selecting switch 15b, the cross key 19b becomes a selecting switch for selecting any of multiple images that have been already taken.

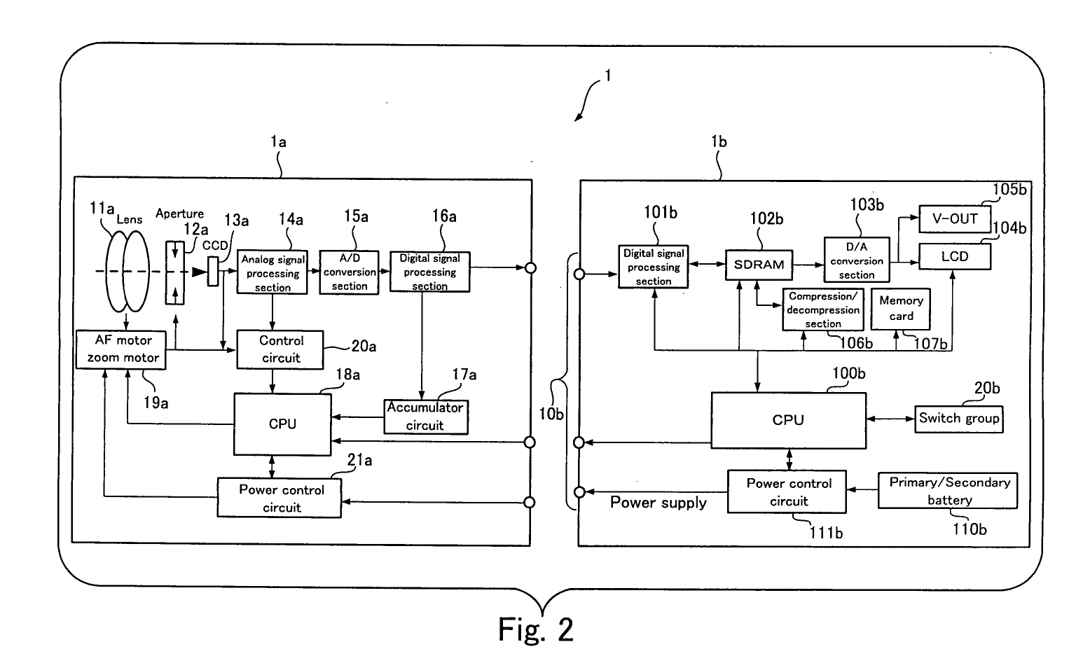

Now, referring to FIG. 2, an internal arrangement of the camera head 1a and the camera main unit 1b will be described.

FIG. 2 is a block diagram showing an arrangement of an electric system of the camera head 1a and the camera main unit 1b to which the camera head 1a is attached.

The left part of FIG. 2 shows an arrangement of the camera head 1a, and the right part of FIG. 2 shows an arrangement of the camera main unit 1b.

The arrangement of the camera head 1a will be described first.

The camera head 1a operates with the power supplied by a primary/secondary battery 110b that is provided in the camera main unit 1b. Once the camera head 1a is attached to the camera main unit 1b, the power is supplied from the primary or secondary battery 110b to each component of the camera head 1a through the followings: a power control circuit 111b of the camera main unit 1b; any of the multiple mount contacts of the head mount 10b; a mount contact of the head mount of the camera head 1a, which is in contact with the mount contact of the head mount 10b; and a power control circuit 21b of the camera head 1a. Therefore, the camera head 1a does not operate unless it is attached to the camera main unit 1b. Upon attachment of the camera head 1a to the camera main unit 1b, the power is supplied to the camera head 1a and a CPU 18a of the camera head 1a starts processing. Hereinafter, the description will be given based on the premise that the camera head 1a is attached to the camera main unit 1b.

The internal structure of the camera head 1a will be briefly described.

As shown in FIG. 2, the camera head 1a of the camera system 1 has an image taking optical system composed of an image taking lens 11a and an aperture 12a, and an image pickup device (which is a CCD solid image pickup device in this example and therefore will be referred to as a CCD, hereinafter) 13a. The image taking lens 11a includes a focus lens and a zoom lens. The position of the focus lens is adjusted by the rotation of an AF motor of an AF motor/zoom motor 19a so that the focus can be adjusted. The position of the zoom lens is adjusted by the rotation of a zoom motor of the AF motor/zoom motor 19a so that the focal length can be adjusted. The adjustment to the focus and focal length is performed in response to an instruction given by the CPU 18a to the AF motor/zoom motor 19a. The CPU 18a gives the instruction upon receipt of an accumulated value determined by an accumulator circuit 17a that will be described later. The CPU 18a integrally controls the camera head 1a and communicates with a CPU 100b of the camera main unit 1b via an interface to control the camera head 1a in cooperation with the camera main unit 1b.

Following the adjustment to the exposure and focus under the control of the CPU 18a of the camera head 1a, the image taking lens 11a thus adjusted forms an image of the subject light on an image pickup device such as the CCD 13a. Upon the formation of the image of the subject light by the image taking lens 11a of the image taking optical system, an image signal based on the subject is produced by the CCD 13a and the produced image signal is output to an analog signal processing section 14a where the image signal is subjected to processing such as noise reduction processing. Subsequently, the processed analog image signal is converted into a digital image signal by an A/D conversion section 15a and further processed by a digital signal processing section 16a. The image signal processed by the digital signal processing section 16a is supplied to the camera main unit 1b via any of mount contacts of the head mount. The image signals supplied to the camera main unit 1b via the mount contact include three types of signals: an image signal for through image (hereinafter referred to as “through image signal”), which is to display, on an LCD panel (not shown), an image of the subject light that is captured by the image taking lens in the image taking optical system when the image taking mode is selected via the mode selecting switch 15b; an image signal for static image (hereinafter referred to as “static image signal”), which is obtained through operation of the release button 12b; and an image signal for moving image (hereinafter referred to as “moving image signal”), which is obtained through operation of the release button 12b when the moving image mode is selected via the mode selecting switch 15b. Any of such image signals is transmitted to the camera main unit 1b through the interface in response to a request from the camera main unit 1b.

On the other hand, the image signals processed by the digital signal processing section 16a are also supplied to the accumulator circuit 17a, which provides an AF function (referred to simply as AF, hereinafter) and an AE function (referred to simply as AE, hereinafter). The accumulator circuit 17a measures the luminance of field required to provide the AE function and the depth of field (a distance between a subject and a camera) required to provide the AF function. The depth of field and the luminance of field measured by the accumulator circuit 17a are supplied to the CPU 18a at predetermined intervals, and the CPU 18a reads the information about the depth of field and the luminance of field and supplies an instruction according to the read information to the AF motor/zoom motor 19a at predetermined intervals. Upon receipt of the instruction, the AF motor/zoom motor 19a adjusts the aperture in the image taking optical system, the position of the focus lens of the image taking lens in the image taking optical system, and the position of the zoom lens. Incidentally, the AF motor/zoom motor 19a also includes a motor for adjusting the aperture 12a. With this arrangement, each time the image taking lens 11a in the image taking optical system of the camera head 1a is aimed at a different subject, the AF or AE immediately operates to adjust the focus or luminance, and the CCD 13a produces and outputs an image signal representing the subject focused.

In addition, since the positions of the focus lens and the zoom lens have to be detected during the adjustment to the positions of the focus lens and the zoom lens by the rotation of the AF motor and the zoom motor, a signal representing the lens position, such as an encoder pulse, is supplied to a control circuit 20a and further supplied therefrom to the CPU 18a. This allows the CPU 18a to count the number of encoder pulses and give timely instructions for driving the AF motor and the zoom motor to the AF motor/zoom motor 19a so that the focus lens and the zoom lens can be arranged at appropriate positions. At this point, output signals from the CCD 13a and the analog signal processing section 14a are also supplied to the control circuit 20a so that the control circuit 20a can detect a change in the image signal output from the CCD 13a while the focus lens or zoom lens is moving, and the result of the detection is supplied from the control circuit 20a to the CPU 18a.

The CPU 18a incorporates an internal memory and controls the AF motor/zoom motor 19a and the like in accordance with the procedures of a program stored in the internal memory. The internal memory also stores a program that specifies processing procedures of the AE and AF as well as processing procedures of communications via the interface. In addition, the internal memory also stores a through image processing program and a static image processing program that are activated when the image taking mode is selected via the mode selecting switch 15b, a moving image processing program that is activated when the moving image taking mode is selected, a reproduction processing program that is activated when the reproduction mode is selected, and the like. In accordance with these programs, the CPU 18a controls the operation of the accumulator circuit 17a, the interface, and the like.

Now, the arrangement of the camera main unit 1b will be described.

The camera main unit 1b also has a digital signal processing section 101b and the CPU 100b integrally controls the operation of each section including the digital signal processing section 101b.

First, there will be described how a through image signal sent from the camera head 1a is processed under the control of the CPU 100b. The operations described below will be all performed under the control of the CPU 100b.

A through image signal output from the digital signal processing section 16a of the camera head 1a is supplied to the digital signal processing section 101b via a mount contact and the image signal processed by the digital signal processing section 101b is stored in a SDRAM 102b. The image signal stored in the SDRAM 102b is supplied to a LCD 104b via a D/A conversion section 103b and a through image based on the image signal is displayed on the LCD 14b of the LCD 104b. At this point, the through image signal can be output from a V-OUT terminal 105b so that a through image based on the image signal may be displayed on an external display device.

In this state, when the release button 12b as a part of the switch group 20b in the camera main unit 1b is pressed, the image taking timing is sent from the CPU 100b of the camera main unit 1b to the CPU 18a of the camera head 1a via the communication interface. Upon receipt of the image taking timing, the CPU 18a of the camera head 1a instructs the CCD 13a to start exposure in accordance with the image taking timing and output an image signal after a predetermined exposure time. Actually, the CPU 18a gives an image taking instruction to a timing generator (not shown) and the timing generator supplies an image taking start and end signal to the CCD 13a so that an image signal can be output from the CCD 13a in accordance with the release timing.

The image signal thus output is supplied to the digital signal processing section 101b and further to a compression/decompression section 106b via the SDRAM 102b, and the signal compressed there is stored in a memory card 107b.

There will be described below the initialization processing procedure executed by the CPU 100b of the camera main unit 1b and the CPU 18a of the camera head 1a in cooperation with each other when the camera head 1a is attached to the camera main unit 1b and the power switch 13b is pressed.

As described above, the CPU 100b controls the display of a menu screen that is displayed on the LCD panel 14b of the LCD 104b in the camera main unit 1b, as well as controls the allocation of the functions of the upper and lower keys and the like of the cross key 19b. In addition, since the CPU 100b has association information in which the control descriptions are associated with the instructions sent from the cross key 19b for plural types of camera heads, the CPU 100b can control the operation of a camera head attached to the camera main unit 1b according to the control description obtained from the association information. The CPU 100b can rewrite the association information to make it suitable for the camera head 1a when the camera head 1a is attached to the camera main unit 1b.

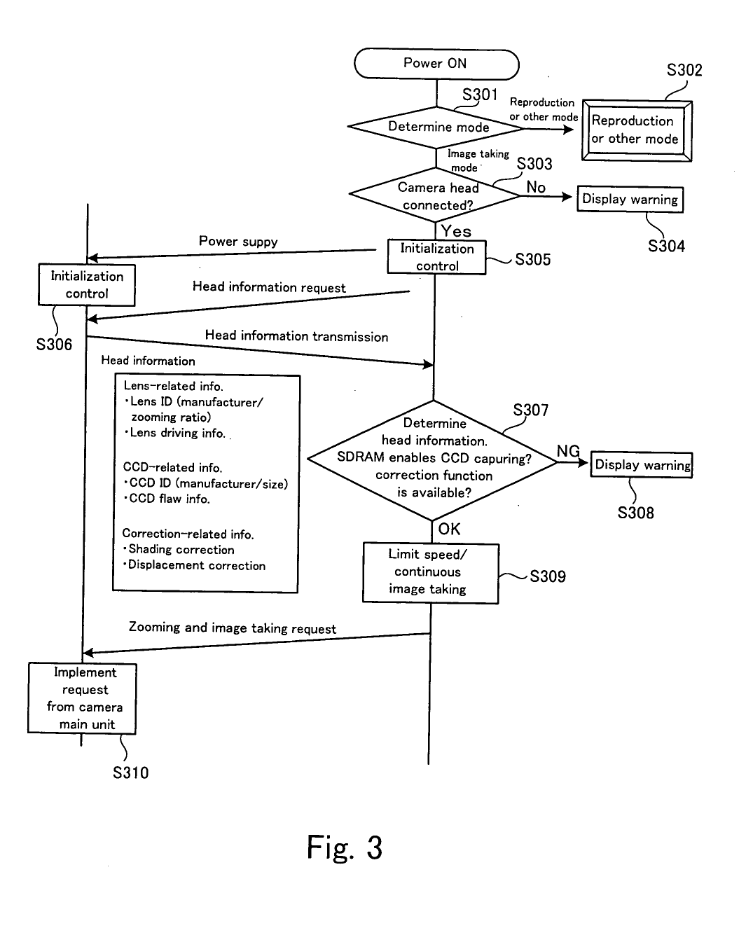

FIG. 3 is a flowchart showing the initialization processing procedure that are performed by the CPU 100b of the camera main unit 1b and the CPU 18a of the camera head 1a in cooperation with each other. The left side of FIG. 3 shows the processing procedure performed by the CPU 18a of the camera head 1a, whereas the right side of FIG. 3 shows the processing procedure performed by the CPU 100b of the camera main unit 1b. As shown in FIG. 3, the initialization processing is performed by the CPU 100b of the camera main unit 1b and the CPU 18a of the camera head 1a in cooperation with each other, but the processing performed by the CPU 18a and that by the CPU 100b will be described sequentially. More particularly, the processing performed by the CPU 18a of the camera head 1a will be described when the CPU 18a operates and the processing performed by the CPU 100b of the camera main unit 1b will be described when he CPU 100b operates.

When the power is tuned on, the processing in this flow chart begins.

First, the CPU 100b of the camera main unit 1b starts the processing.

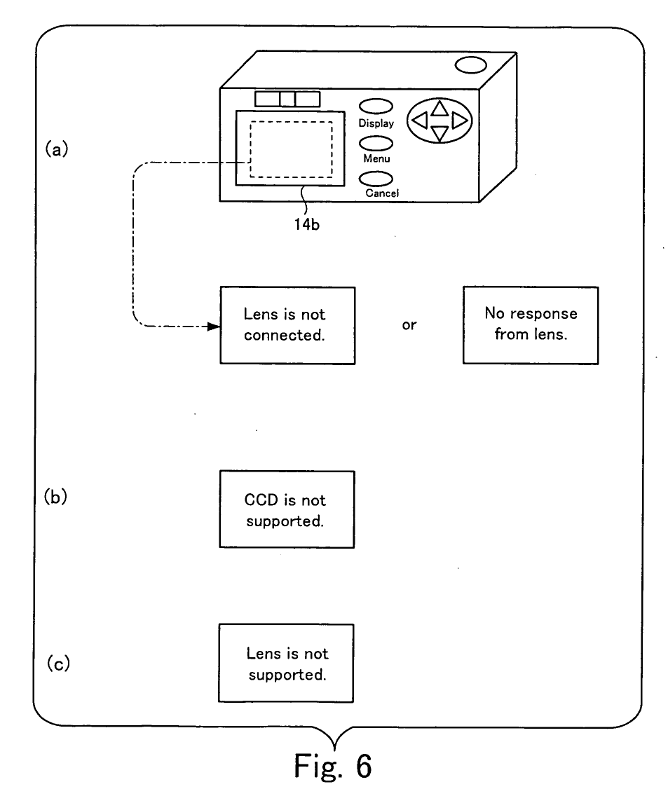

The CPU 100b determines whether the mode is the image taking mode or the reproduction mode at step S301. If the mode is the reproduction mode, the process goes to step S302 where the processing is performed in the reproduction or other mode at step S302. If the mode is the image taking mode, the process goes to step S303 in which whether the camera head 1a is attached to the camera main unit 1b or not is determined. If the result is YES, the process goes to step S305 where the initialization control is performed. If the result is NO at step S303, the process goes to step S304 where a warning is displayed (see part (a) of FIG. 6).

When the power is supplied from the camera main unit 1b to the camera head 1a at step S305, the CPU 18a of the camera head 1a starts the processing and performs the initialization control. At this point, if the camera main unit 1b sends a head information transmission request via the communication I/F at step S306, upon receipt of the request, the CPU 18a transmits the head information about the camera head 1a to the camera main unit 1b.

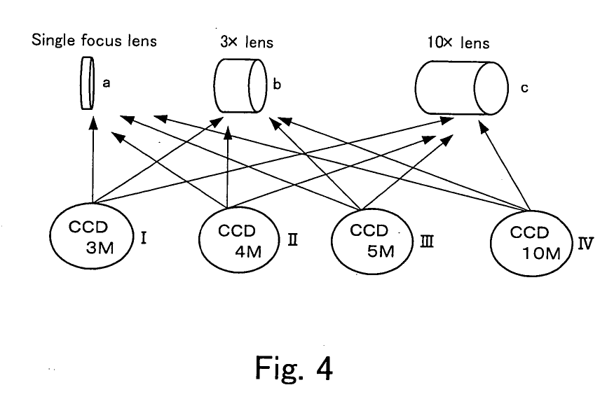

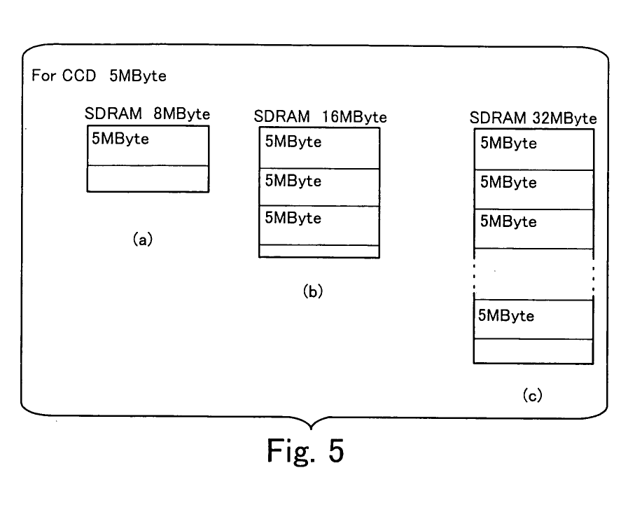

Upon receiving the head information, the CPU 100b of the camera main unit 1b determines what the type of the camera head 1a is. In this example, the information sent from the camera head 1a to the camera main unit 1b as the head information are as follows: ID information (manufacturer/zooming ratio) and driving information about the image taking lens 11a, ID information (manufacturer/size) and flaw information about the CCD 13a, and correction information such as shading correction and displacement correction. Then, at step S307, the number of pixels of the CCD 13a is compared with the capacity of the SDRAM 102b serving as an image buffer, and it is determined whether correction functions based on the shading correction, the displacement correction, and the like are available or not. In addition, at step S307, processing variables can be rewritten based on the information about the association with the camera head 1a. In this example, if it is determined that the capacity of the SDRAM 102b is less than the number of pixels in the CCD size information of the head information, continuous image taking cannot be performed, and thus, the process goes to step S308 where a warning is displayed (see parts (b) and (c) of FIG. 6). The details of the displayed warning will be described later with reference to FIG. 6. On the other hand, if it is determined that the capacity of the SDRAM 102b is equal to or more than the number of pixels in the CCD size information of the head information, continuous image taking can be performed, however, the number of frames may be limited. In this case, processing for limiting speed/continuous image taking is performed in the next step S309. The details of such limiting processing will be described later with reference to FIGS. 4 and 5.

Subsequently, if the release button 12b or the cross key 19b is operated, the camera main unit 1b sends an image taking request or a zooming request to the camera head 1a by controlling the communication interface. Upon receipt of the request, the CPU 18a of the camera head 1a performs processing according to the request in step S310 and sends an image signal according to the request to the camera main unit 1b.

Now, with reference to FIGS. 4 and 5, there will be described what types of camera heads and camera main units may be used as the plural types of camera heads and the plural types of camera main units.

FIG. 4 illustrates plural types of camera heads, whereas FIG. 5 illustrates plural types of camera main units.

FIG. 4 shows: focal-length variable lenses and a single focus lens as examples of the image taking lens incorporated in the camera head 1a; and different types of CCD 13a having different sizes. FIG. 5 shows different types of SDRAM 102b serving as a buffer memory for image processing, which have different capacities.

As shown in FIG. 4, suppose there are: one single focus lens and two 3× and 10× focal-length variable lenses as image taking lenses; and four CCDs whose number of pixels are different, i.e. 3M, 4M, 5M and 10M. Then, twelve combinations (3 ×4 =12) are available.

In addition, suppose there are three types of SDRAMs different incapacity, i.e. an 8-, a 16-, and a 32-Mbyte SDRAMs as shown in FIG. 5. In total, there are twelve types of camera heads and three types of camera main units, and thus, thirty-six combinations (12×3=36) are available in all. The number of combinations mentioned above is only an example, and in fact, more combinations are conceivable.

In the present embodiment, at least one of the plural types of camera main units has the CPU 100b as the determination means for determining whether a camera head attached to the camera main unit includes an unsupportable function. If the CPU 100b determines that the CPU 100b cannot support that function, a warning is displayed on the LCD panel. The CPU 100b of this camera main unit corresponds to the determination means according to the invention, and the combination of the CPU 100b and the LCD panel 14b for displaying a warning corresponds to the warning means according to the invention.

For example, if the camera head 1a has a 10-Mbyte CCD and the camera main unit 1b has an 8-Mbyte SDRAM among the above combinations, the camera main unit 1b cannot process an image signal sent from the camera head 1a, and thus, a warning is displayed on the LCD panel. The details of the warning display will be described later.

If the camera head 1a has a 5-Mbyte CCD and the camera main unit 1b has a 16-Mbyte SDRAM among the above combinations, continuous image taking can be performed. However, since the capacity of the SDRAM is not enough, the number of frames in continuous image taking is limited at step S309.

If the camera head 1a has a 5-Mbyte CCD and the camera main unit 1b has a 32-Mbyte SDRAM among the above combinations, normal processing can be performed without limiting the number of frames in continuous image taking at step S309.

FIG. 6 illustrates warning messages to be displayed when the warning processing is performed at step S304 or step S307.

If it is determined that the camera head is not attached to the camera main unit at step S303 in FIG. 3, as shown in part (a) of FIG. 6, warning messages saying “Lens is not connected” and “No response from lens” are displayed on the LCD display panel.

Also, if it is determined that the number of pixels as a CCD size is beyond the capacity of the SDRAM 102b, as shown in part (b) of FIG. 6, a warning message saying “CCD is not supported” is displayed. If a lens of certain manufacturer is not supported by the camera main unit according to CCD information or lens information, as shown in part (c) of FIG. 6, a warning message saying “Lens is not supported” is displayed.

Upon attachment of the camera head 1a to the camera main unit 1b, the CPU 100b of the camera main unit 1b rewrites the information about the association with the camera head according to attached camera head. The contents of the information to be rewritten will be described below.

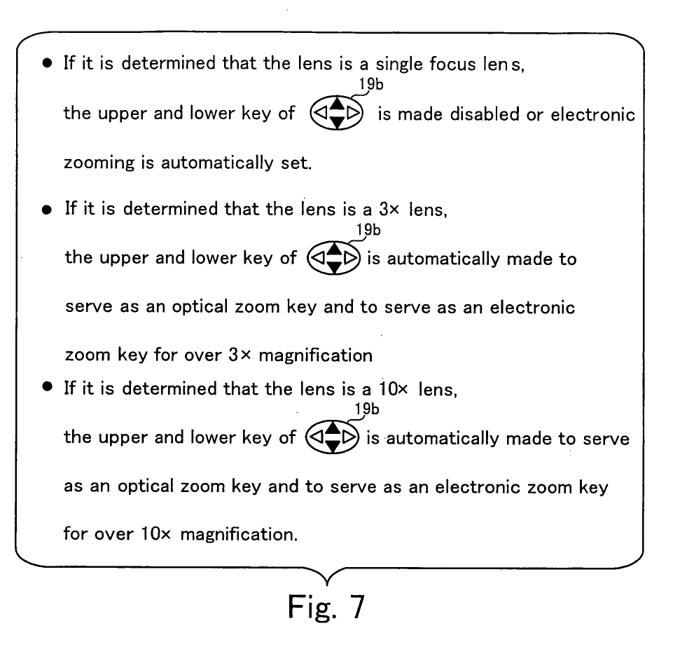

FIG. 7 illustrates the contents, such as processing variables, of the rewriting processing performed by the CPU 100b. In this figure, the cross key 19b is shown in the form of image.

FIG. 7 shows an example in which, upon attachment of the camera head having a single focus lens, the CPU performs processing for rejecting input signals from the upper and lower keys of the cross key 19b. In this example, the rejecting processing is performed because the single focus lens is not capable of zooming. This processing is performed when the camera head incorporating the single focus lens is attached to the camera main unit and the head information is sent to the camera main unit. Alternatively, as similar processing, electronic zooming may be performed by setting processing variables for electronic zooming at the digital signal processing section 101b.

FIG. 7 also shows an example in which, upon attachment of a camera head having a 3× lens, the CPU 100b rewrites the contents of the association information so that the upper and lower key of the cross key 19b may serve as an optical zoom key for up to 3× magnification and serve as an electronic zoom key for over 3× magnification. Further, FIG. 7 shows an example in which, upon attachment of a camera head having a 10× lens, the CPU 100b rewrites the contents of the association information so that the upper and lower key of the cross key 19b may serve as an optical zoom key for up to 10× magnification and as an electronic zoom key for over 10× magnification.

With this arrangement, the camera system can be appropriately operated by changing the function of the cross key in a user-transparent manner to serve as a zoom key for example, depending on the combination of the camera head la and the camera main unit 1b. In addition, when an instruction to operate a function that is not supported by the attached camera head is provided by the user's operation, the camera system can inform the user that the operation is invalid by displaying a warning.

As described above, there is realized a camera system that is easy to use and appropriately operates depending on the combination of a camera head and a camera main unit, in which any of plural types of camera heads is attached to any of plural types of camera main units.

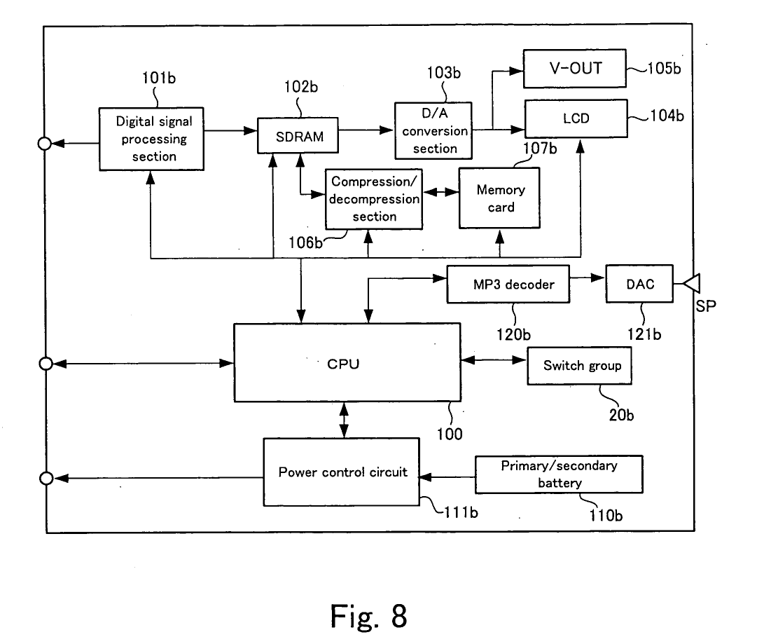

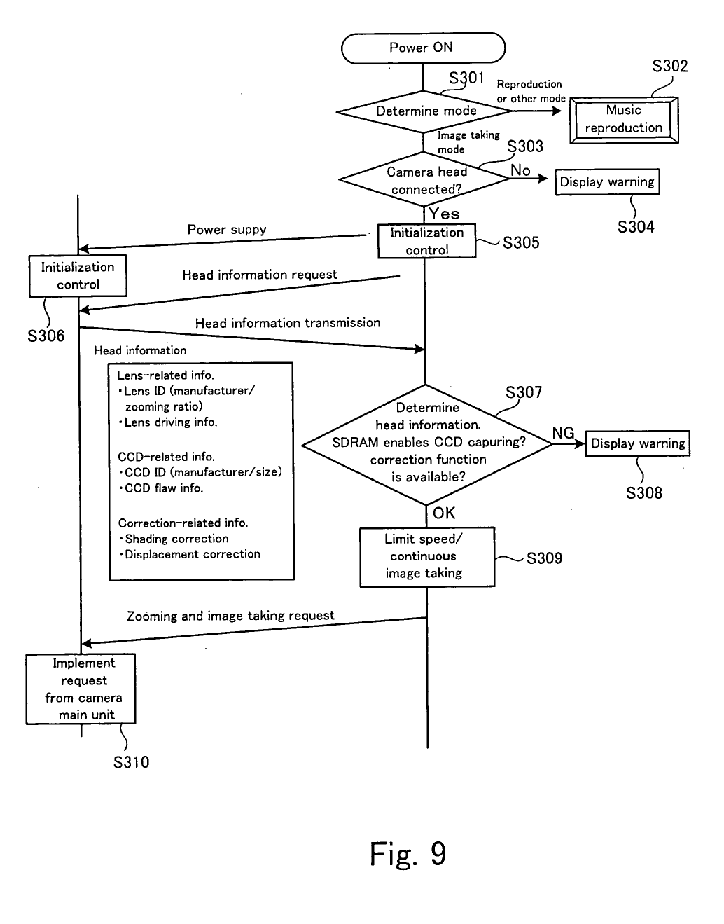

FIG. 8 illustrates the same arrangement as that of the camera main unit shown in FIG. 2 except that a sound decoder called MP3 decoder is included therein. FIG. 9 illustrates an example in which music is reproduced by the sound decoder in processing at step S302.

This camera main unit 1b operates in cooperation with the attached camera head 1a in the image taking mode and the moving image mode, and operates independently of the camera head 1a in the reproduction mode. The image taking mode and the moving image mode each correspond to the first mode according to the present invention, and the reproduction mode corresponds to the second mode according to the present invention.

Specifically, the camera main unit 1b operates only by itself and reproduces music in the reproduction mode selected by the mode selecting switch 15b, even when the camera head 1a is not attached to the camera main unit 1b.

For example, as shown in FIG. 9, if the CPU 100b of the camera main unit determines that the mode is the reproduction mode in step S301 of the flowchart in FIG. 3, the process goes to step S302 where music can be reproduced based on a MIDI file in the internal memory within the CPU 100b. Alternatively, a taken image may be reproduced based on an image signal in a taken image file.

As described above, there can be realized a camera system that is easy to use and operates only by the camera main unit 1b in a state in which the camera head 1a is not attached to the camera main unit 1b.

1. A camera system, comprising: a plurality of types of camera heads each having an image taking optical system and an image pickup device; and a camera main unit to which any of the plurality of types of camera heads is interchangeably attached and which receives an image signal from the attached camera head and performs signal processing,
wherein the camera main unit includes:
operation means for providing an instruction to the camera main unit and to the camera head attached to the camera main unit in response to an operation; and
control means for controlling, upon receipt of an instruction from the operation means, the operation of the camera main unit and the camera head attached to the camera main unit in accordance with a control description obtained from association information in which instructions from the operation means are associated with control descriptions, the association information being retained in the control means,
wherein in response to attachment of the camera head to the camera main unit, the control means rewrites the association information according to the camera head attached to the camera main unit.

2. A camera system, comprising: a plurality of types of camera heads each having an image taking optical system and an image pickup device; and a plurality of types of camera main units, to each of which any of the plurality of types of camera heads is interchangeably attached and each of which receives an image signal from the attached camera head and performs signal processing,
wherein, of the plurality of types of camera main units, at least one type of camera main unit includes:
determination means for determining whether an unsupportable function is included in the functions of the camera head attached to the one type of camera main unit; and
warning means for warning when the unsupportable function is included.

3. A camera system, comprising: a camera head having an image taking optical system and an image pickup device; and a camera main unit, to which the camera head is removably attached and which receives an image signal from the attached camera head and performs signal processing,
wherein the camera system includes a first mode for operation performed in cooperation with the attached camera head and a second mode for operation performed independently of the camera head, and
wherein the camera main unit performs the operation in the second mode when the camera head is not attached to the camera main unit.

4. A camera main unit to which any of a plurality of types of camera heads each having an image taking optical system and an image pickup device is interchangeably attached, and which receives an image signal from the attached camera head and performs signal processing,
wherein the camera main unit includes:
operation means for providing an instruction to the camera main unit and to the camera head attached to the camera main unit in response to an operation; and
control means for controlling, upon receipt of an instruction from the operation means, the operation of the camera main unit and the camera head attached to the camera main unit in accordance with a control description obtained from association information in which instructions from the operation means are associated with control descriptions, the association information being retained in the control means,
wherein in response to attachment of the camera head to the camera main unit, the control means rewrites the association information according to the camera head attached to the camera main unit.

5. A camera main unit which is one type of camera main unit of a plurality of types of camera main units, to which any of a plurality of types of camera heads each having an image taking optical system and an image pickup device is interchangeably attached, and which receives an image signal from the attached camera head and performs signal processing,
wherein the camera main unit includes:
determination means for determining whether an unsupportable function is included in the functions of the camera head attached to the one type of camera main unit; and
warning means for warning when the unsupportable function is included.
